(19) United States
(12) Patent Application Publication
(10) Pub. No.: US 2017/0300100 A1
(43) Pub. Date: Oct. 19, 2017

(54) POWER SUPPLY DEVICE AND SERVER SYSTEM PROVIDED WITH SAME

(71) Applicant: Fuji Electric Co., Ltd., Kanagawa (JP)

(72) Inventors: Yuuji TAKEUCHI, Mie (JP); Shinji HATAKENAKA, Mie (JP)

(73) Assignee: Fuji Electric Co., Ltd., Kanagawa (JP)

(21) Appl. No.: 15/641,555

(22) Filed: Jul. 5, 2017

Related U.S. Application Data
(63) Continuation of application No. PCT/JP2016/057516, filed on Mar. 10, 2016.

(30) Foreign Application Priority Data
Jul. 3, 2015 (JP) 2015-134645
Jul. 6, 2015 (JP) 2015-135037

(51) Int. Cl. G06F 1/26; G06F 1/18

(52) U.S. Cl. CPC G06F 1/266; G06F 1/189

(57) ABSTRACT

A power supply unit for converting AC power into DC power and a battery unit for converting power stored in a battery into DC power and outputting the same are both accommodated in one shelf to form an uninterruptible power supply device, and the DC output terminals of the power supply unit and the DC output terminals of the battery unit are connected in parallel within the shelf by a connection conductor module that holds a connection conductor therein. The connection conductor module is composed of a module case formed from an insulating material and an electrically conductive connection conductor.

### BACKGROUND OF INVENTION

### Technical Field

The present invention relates to a power supply device that supplies DC power to a server system installed in a data center, for example, and a server system provided with the power supply device.

### Background Art

FIG. 19 is a schematic diagram showing a conventional typical power supply system for server systems as disclosed in Patent Document 1.

This power supply system is provided with an uninterruptible power supply device 1 connected to an AC 400V system power supply 3, and a transformer 2 that isolates and converts AC power voltage outputted from the uninterruptible power supply device 1.

The uninterruptible power supply device 1 is provided with a battery 1a, an AC/DC converter 1b, and a DC/AC converter 1c. This battery 1a is charged by the AC/DC converter 1b, which converts AC power from the system power supply 3 into DC power. Then, either DC power is outputted from the AC/DC converter 1b, or DC power discharged from the battery 1a is converted to AC 400V AC power by the DC/AC converter 1c.

The 400V AC power outputted from the DC/AC converter 1c is converted to 200V or 100V AC power by the transformer 2. The converted AC power is further converted to low-voltage (12V) DC power by a power converter 5 inside a server system 4. The power converter 5 is composed of a series circuit of an AC/DC converter 5a and a DC/DC converter 5b. This 12V DC power is supplied to multiple servers 4a-4n, which form a load. The individual servers 4a-4n in the server system run on 12V DC power.

A predetermined number of the servers 4a-4n per server rack are housed in server racks to form a server system. The power converter 5 is provided for each server system. The power converter 5 is housed integrally in each of the server racks housing the servers.

However, in this type of power supply system, many power conversion steps are required because power conversion is performed by many converters, such as AC/DC converters 1b and 5a, and DC/DC converter 5b. This results in a fall in overall power conversion efficiency. A power supply system for supplying DC power as shown in FIGS. 20 and 21 was therefore proposed.

The power supply system shown in FIG. 20 supplies high-voltage (400V) DC power outputted from the AC/DC converter 1b in the uninterruptible power supply device 1 to the server system 4 via a DC power distribution device 2a. The high-voltage (400V) DC power is converted to low-voltage (12V) DC power by a DC/DC converter 5d inside the server system 4. This power supply system is called a high-voltage direct current electricity supply system (HVDC).

In the power supply system shown in FIG. 21, the uninterruptible power supply device 1 is further provided with a DC/DC converter 1d. The 400V DC power outputted from the AC/DC converter 1b is converted to low-voltage (48V) DC power by the DC/DC converter 1d. This low-voltage (48V) DC power is fed to the server system 4 via the DC power distribution device 2a. This low-voltage (48V) DC power is further converted to low-voltage (12V) DC power by a DC/DC converter 5e inside the server system 4. This power supply system is called a low-voltage direct current electricity supply system.

This type of power supply system for supplying DC power has few power conversion steps and can therefore increase power conversion efficiency.

However, in the power supply system for supplying high-voltage direct current shown in FIG. 20, a DC power distribution circuit breaker 2a is needed as a circuit breaker for interrupting high-voltage DC power. Circuit breakers capable of interrupting high-voltage DC power are not only large but also necessitate electric shock countermeasures for DC high-voltage (DC 400V) power distribution.

In contrast, the power supply system of FIG. 21 handles low-voltage high-current DC, and therefore has the problem of increased loss and heat generation in conductors on power distribution wiring etc.

In the power supply system shown in FIG. 19, a large uninterruptible power supply device 1 with high capacity of at least several 100 kW is centrally configured in a data center. For this reason, the uninterruptible power supply device occupies a large installation space when installed in a data center. Moreover, when the uninterruptible power supply device 1 develops a fault, all the servers will shut down, which decreases the reliability of the overall system.

The power supply system shown in FIG. 22 was proposed in Patent Document 1 in order to solve these problems in conventional power supply systems.

The power supply system shown in FIG. 22 supplies 200V AC power supplied from the AC system power supply 3 to the server system 4. An uninterruptible power supply device 10 and a plurality of servers 4a-4n are accommodated in a server rack 40 in the server system 4. The uninterruptible power supply device 10 is composed of a power supply unit 20 and a battery unit 30. A power supply circuit 21 in the power supply unit 20 is provided with an AC/DC converter 22 that converts AC power fed from the system power supply 3 to DC power, and a DC/DC converter 23 that converts DC power outputted from the AC/DC converter 22 to 12V DC power. The 12V DC power outputted from the DC/DC converter 23 is supplied to the servers 4a-4n.

In addition, a battery circuit 31 in the battery unit 30 is provided with a battery 32 that is charged with DC power and a DC/DC converter 33 that conducts DC current in both directions. The battery 32 is connected in parallel to the output of the power supply circuit 21 via the bidirectional DC/DC converter 33. The battery 32 is charged by DC power from the power supply circuit 21 through the bidirectional DC/DC converter 33, and the charged DC power is supplied to the servers 4a-4n via the DC/DC converter 33.

The power supply unit 20 and battery unit 30 configured in this way are both housed in the same shelf 50, as shown in FIGS. 23A and 23B, to form the uninterruptible power supply device 10. Output terminals leading out from the rear side of the power supply unit 20 and battery unit 30 are connected to power bus bars 42 and 43 in the server rack 40 via a connector 44. The power bus bars 42 and 43 are connected to the power supply input terminal of the server (load) 4, which is not illustrated here.

### RELATED ART DOCUMENT

### Patent Document

Patent Document 1: WO 2014/141486

### SUMMARY OF THE INVENTION

When a power supply unit and a battery unit are housed together with a server in a server rack in this way, the installation space required is smaller than when separately installing an uninterruptible power supply device. Furthermore, if the uninterruptible power supply device develops a fault, the effect of this fault will be limited to servers housed in that server rack, and servers in other server racks will be unaffected. The reliability of the server system can therefore be increased.

However, this type of conventional uninterruptible power supply device requires each power supply unit to be connected to a DC bus bar via a connector at the rear of the power supply unit and battery unit. This presents the problem that a large number of connectors are required according to the number of power supply units and battery units, and connecting these components requires work.

The present invention addresses the problem of providing a power supply system in which a power supply unit and battery unit are connected to each other within a housing case, thereby facilitating connection with a DC bus bar within a server rack. Accordingly, the present invention is directed to a scheme that substantially obviates one or more of the problems due to limitations and disadvantages of the related art.

Additional or separate features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, in one aspect, the present disclosure provides a power supply device for supplying DC power, including:

a plurality of power conversion units that output the DC power;

a connection conductor module that connects in parallel output terminals of the plurality of power conversion units; and

a shelf that accommodates the plurality of power conversion units and the connection conductor module,

wherein the connection conductor module includes a module case made of an insulating material and connection conductors accommodated within the module case.

In one aspect of the present invention, the module case has an opening in a surface facing the plurality of power conversion units, the connection conductors include terminals to fit with the output terminals of the plurality of power conversion units, and the terminals of the connection conductors fit and connect with the output terminals of the plurality of power conversion units at the opening.

In addition, in one aspect of the present invention, the module case includes a first case and a second case, and the connection conductors are fixed and retained inside the module case by the fitting together of the first case and the second case.

In one aspect, the connection conductors are installed and fixed in a retaining groove provided in the first case or the second case.

Furthermore, in one aspect of the present invention, the connection conductor module includes a fitting to fit with a fitting provided on at least one of a side wall and a bottom wall of the shelf.

In one aspect, the connection conductors and the shelf are insulated by the module case at a top, bottom, and both sides of the connection conductor module.

Furthermore, in one aspect of the present invention, each of the plurality of power conversion units that output DC power is either a power supply unit that converts power from an AC power supply to DC power and outputs the same, or a battery unit that converts battery power to DC power and outputs the same.

Furthermore, in one aspect of the present invention, the connection conductors include a pair of terminals of positive polarity and negative polarity provided on both left and right sides of the power supply device, for extracting the DC power externally.

A server power supply system can be configured by means of the power supply device of the present invention. In this case, it is desirable to accommodate the power supply device in a server rack housing a server.

According to the present invention, a power supply device is provided with a power supply unit, a battery unit, and a connection conductor module. A module case is removably installed in a shelf that accommodates the power supply unit and battery unit. The power supply unit and battery unit are inserted in the shelf of the power supply device so that the respective output terminals of the power supply unit and battery unit are electrically connected in parallel with the connection conductors in the connection conductor module. The connection conductors are held in place by the module case, which is formed from an insulating material. By fitting and connecting the connection terminals of the connection conductor module to the output terminals of the power supply unit and battery unit, a plurality of units can easily be connected in parallel within the power supply device.

It is to be understood that both the foregoing general description and the following detailed description are exemplary and explanatory, and are intended to provide further explanation of the invention as claimed.

### BRIEF DESCRIPTION OF THE DRAWINGS

FIGS. 1A and 1B are schematic illustrations of a server system according to the present invention. FIG. 1A is a front sectional view and FIG. 1B is a side sectional view.

FIGS. 2A and 2B are front views of an uninterruptible power supply device according to the present invention. FIG. 2A is a front view showing the shelf without any units housed in any of the compartments. FIG. 2B is a front view showing the shelf with units housed in each compartment.

FIG. 3 is a perspective view showing the power supply unit and battery unit while being inserted in the shelf of the uninterruptible power supply device.

FIG. 4 is a perspective view showing the power supply unit and battery unit after insertion into the shelf of the uninterruptible power supply device.

FIG. 5 is a partially enlarged perspective view showing the process of insertion of the connection conductor module in FIG. 4.

FIG. 6 is a perspective view showing the uninterruptible power supply device after completion of assembly.

FIG. 7 is an exploded perspective view showing the configuration of the connection conductor module.

FIG. 8 is a perspective view showing the configuration of the connection conductor module from the opposite direction to that of FIG. 7.

FIG. 9 is a front view showing the configuration of the connection conductor module during assembly.

FIG. 10 is a perspective view showing the configuration of the connection conductor module when assembled.

FIG. 11 is a perspective view showing the exterior of the uninterruptable power supply device.

FIG. 12A is an enlarged plan view showing the connection terminals of the uninterruptable power supply device; FIG. 12B is a further enlarged plan view of part A in FIG. 12A.

FIG. 13 is a perspective view showing the uninterruptible power supply device with part of the cover plate removed.

FIG. 14 is a perspective view showing the connection structure of the output terminals and lead-out conductors of the uninterruptible power supply device and connection conductor module.

FIGS. 15A to 15C are lengthwise sectional views showing the battery unit when housed in the shelf compartment; FIG. 15A shows the compartment with the battery pulled out, FIG. 15B shows the battery unit inserted to just before the flap, and FIG. 15C shows the battery unit having reached the flap position.

FIG. 16 is a further enlarged view of part A in FIG. 15C.

FIGS. 17A and 17B show the flap when closed in the shelf compartment; FIG. 17A is a plan view, and FIG. 17B is a partially cut away perspective view.

FIGS. 18A and 18B show the flap when open in the shelf compartment; FIG. 18A is a plan view, and FIG. 18B is a partially cut away perspective view.

FIG. 19 is a block diagram showing the configuration of a conventional server system power supply system.

FIG. 20 is a block diagram showing an alternative configuration of a conventional server system power supply system.

FIG. 21 is a block diagram showing an alternative configuration of a conventional server system power supply system.

FIG. 22 is a block diagram showing an alternative configuration of a conventional server system power supply system.

FIGS. 23A and 23B are schematic perspective views of the server system power supply system shown in FIG. 22; FIG. 23A is a perspective view seen from the front, and FIG. 23B is a perspective view seen from the rear.

### DETAILED DESCRIPTION OF EMBODIMENTS

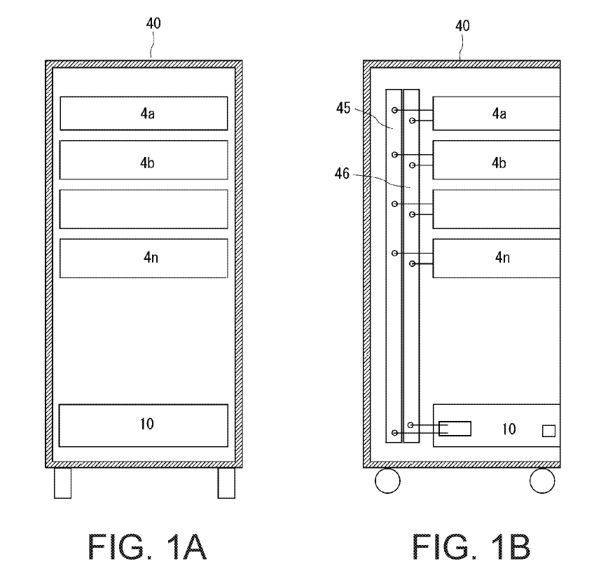

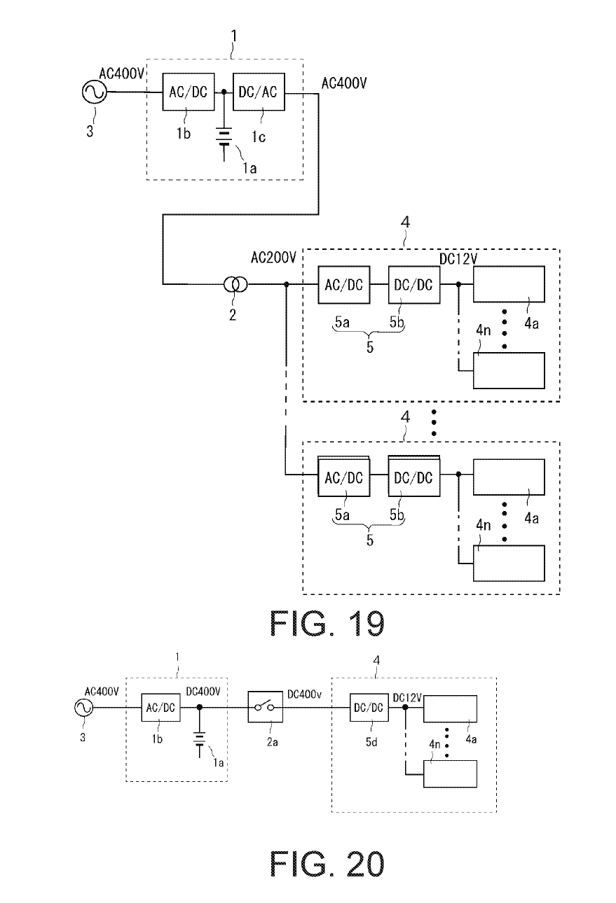

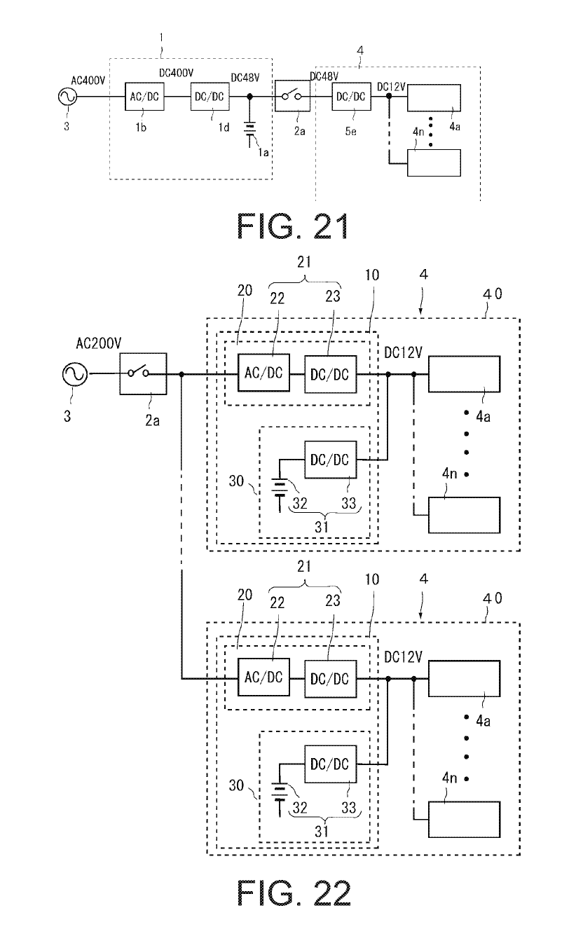

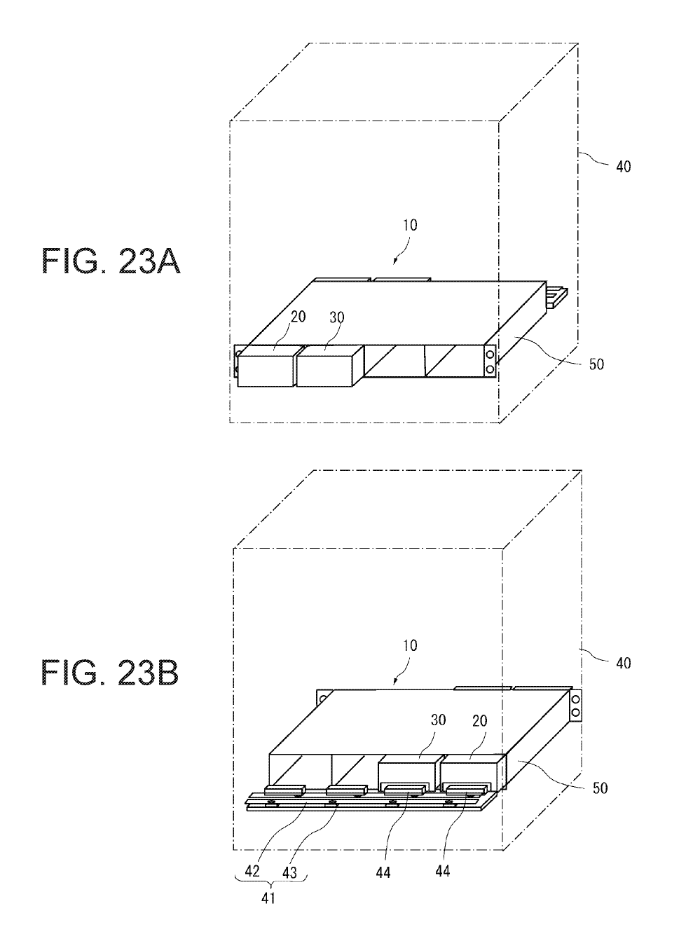

An uninterruptible power supply device and a power supply system according to one embodiment of the present invention are described below with reference to FIGS. 1A and 1B to FIG. 18. The schematic circuit configuration of the power supply system described below is the same as the schematic circuit configuration of the power supply system shown in FIG. 22. In FIGS. 1-18, the same or equivalent elements to those of the conventional server system described using FIGS. 19-23 are designated by the same reference characters.

FIGS. 1A and 1B show schematic configurations of a server system contained within a server rack 40. The server rack 40 contains a plurality of server units 4(a-n) stacked on multiple levels, and an uninterruptible power supply device 10. FIG. 1A is a front view partially cut away to show the configuration within the server rack. FIG. 1B is a side view partially cut away to show the configuration within the server rack.

The server rack 40 is a 19-inch rack standardized by EIA (Electronic Industries Alliance), for example.

The uninterruptible power supply device 10 is composed of a metal shelf 11, and a power supply unit 20, battery unit 30, and connection conductor module 6 described below, etc., which are housed within the shelf 11.

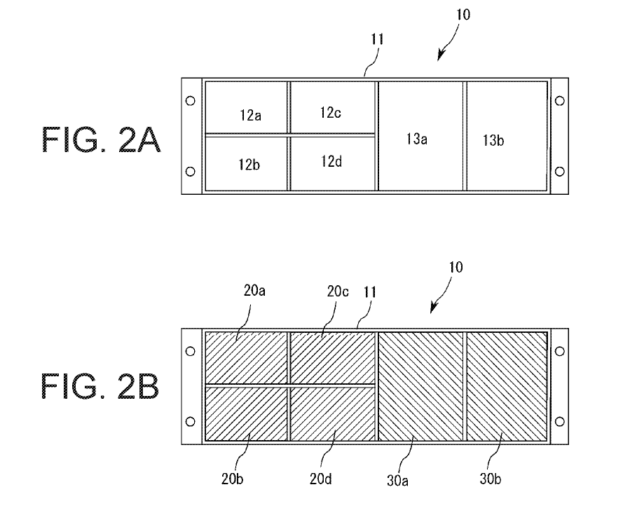

FIG. 2A is front view of the shelf 11 of the uninterruptable power supply device 10. The shelf 11 is provided with a plurality of compartments formed by dividing the shelf into four equal parts along the width direction. The two compartments on the left side are further divided vertically into two levels. Accordingly, the shelf 11 is formed from four small compartments 12(a-d) and two large compartments 13(a,b).

As shown in FIG. 2B, the power supply units 20(a-d) are removably accommodated in the four small compartments 12(a-d). Also, the battery units 30(a,b) are removably accommodated in the large compartments 13(a,b).

The power supply unit 20 is composed of an AC/DC converter 22 and a DC/DC converter 23, as in the conventional device shown in FIG. 22. The AC/DC converter 22 converts AC power supplied from a commercial system power supply 3 into DC power. The DC/DC converter 23 converts the DC power output of the AC/DC converter 22 to DC power voltage (12V, for example) for supplying the server units 4(a-n) and outputs the same. The battery unit 30 is composed of a battery 32 and a bidirectional DC/DC converter 33. When the power supply unit 20 is running, the DC/DC converter 33 charges the battery 32 with DC power outputted from the power supply unit 20. Conversely, when the power supply unit 20 is unable to output power, the DC/DC converter 33 discharges the DC power that was charged to the battery 32 and supplies this DC power to the server 4 load. The DC output part of the power supply unit 20 and the DC output part of the battery unit 30 are electrically connected.

In the working example shown here, the power supply unit 20 is accommodated in a maximum of four of the compartments 12 in the shelf 11, and the battery unit 30 is accommodated in a maximum of two of the compartments 13. The respective number of compartments is determined by the power capacity required by the servers.

Within the server rack 40, apart from the server unit 4 and uninterruptible power supply device 10, a DC bus bar formed from a positive bar conductor 45 and a negative bar conductor 46 is provided. This DC bus bar is electrically connected to the output part of the uninterruptible power supply device 10. DC power outputted from the uninterruptible power supply device 10 is supplied to the server units 4(a-n) via the DC bus bar. A plurality of uninterruptible power supply devices 10 may be housed within the server rack 40. In this case, the DC bus bar is connected in parallel to the output part of each uninterruptible power supply device 10.

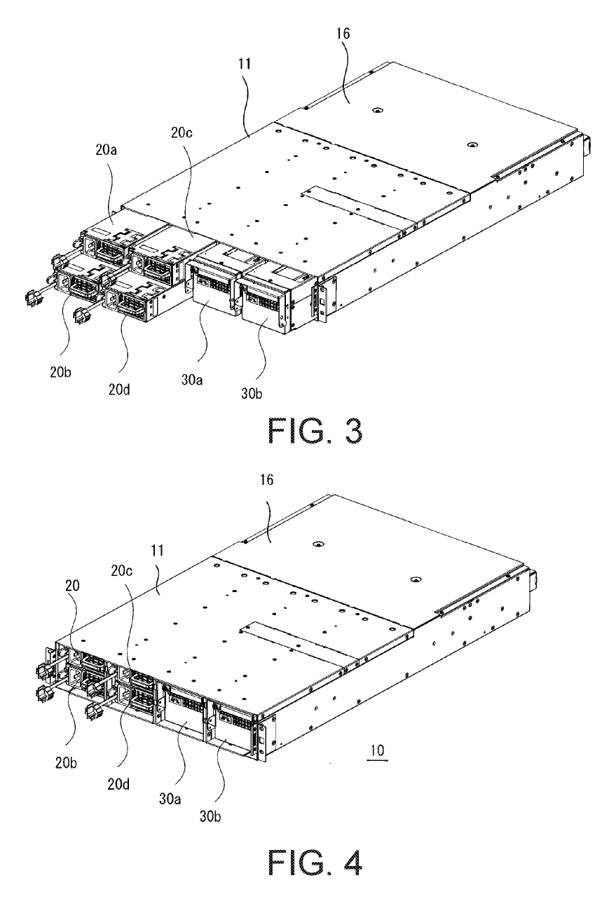

The uninterruptible power supply device 10 of one embodiment of the present invention will be described using FIGS. 3-6.

FIGS. 3-6 show sequentially the configuration of the uninterruptable power supply device 10 during the assembly process.

FIG. 3 shows the four power supply units 20(a-d) and two battery units 30(a,b) during insertion into the shelf 11. FIG. 4 shows the shelf 11 after each unit has been inserted.

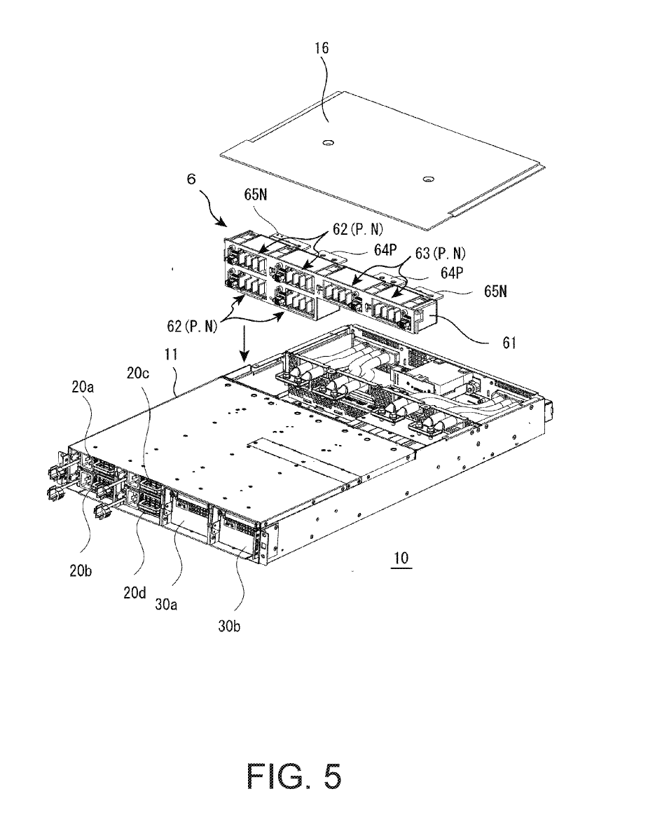

In FIG. 5, the rear top cover 16 of the shelf 11 has been removed and the connection conductor module 6 has been lifted out.

The connection conductor module 6 is installed inside the shelf as described below. The connection conductor module 6 is composed of a module case 61, formed from an insulating material, and an electrically conductive connection conductor unit. The connection conductor unit is composed of connection terminals 62(P,N), connection terminals 63(P,N), lead-out terminals 64P and 65N and connection conductors 64 and 65.

Connection terminals 62(P,N) for connecting with the output terminals of each power supply unit 20, and connection terminals 63(P,N) for connecting with the output terminals of the battery unit 30, are provided at the front openings of the connection conductor module 6. In addition, lead-out terminals 64P and 65N for outputting power externally are provided at the rear of the connection conductor module 6. The connection terminal 62P and the connection terminal 63P are connection terminals on the positive potential side, and are connected to the positive-electrode connection conductor 64. The connection terminal 62N and the connection terminal 63N are connection terminals on the negative potential side, and are connected to the negative-electrode connection conductor 65.

Output terminals are provided at the rear of the power supply unit 20 and the battery unit 30. Each output terminal fits with the connection terminals 62(P,N) and the connection terminals 63(P,N) of the connection conductor module 6.

The power output from the power supply unit 20 and battery unit 30 is extracted externally from the lead-out terminals 64P, 64N, 65P, and 65N.

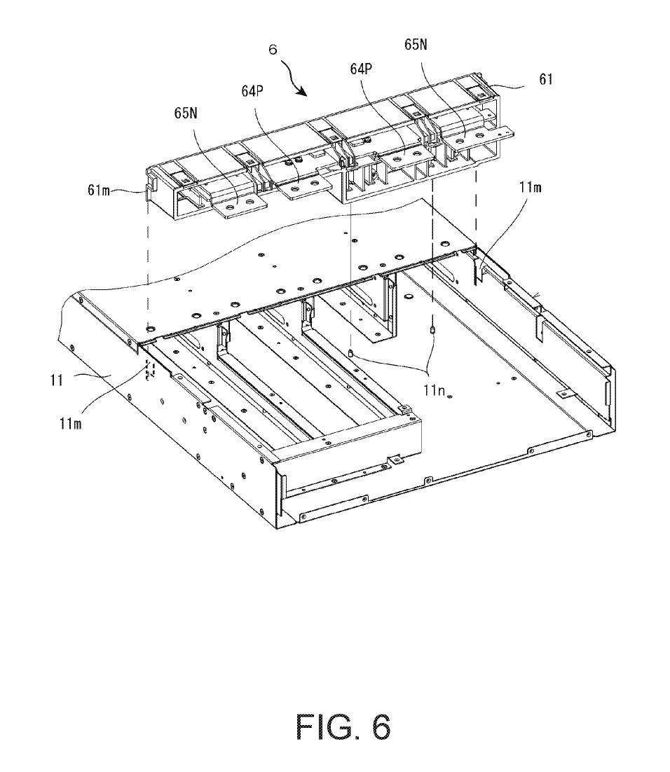

FIG. 6 is an enlarged view of the shelf 11 and the insertion part of the connection conductor module 6. The connection conductor module 6 is fixed to the shelf 11 without using any screws. Specifically, the shelf 11 is provided with a fitting groove 11m on both side walls and a plurality of fitting projections 11n on the bottom wall. Also, the connection conductor module 6 is provided with a fitting member 61m that fits together with the fitting groove 11m, and a fitting hole (not shown) that fits together with the fitting projection 11n in the bottom wall.

When the connection conductor module 6 is inserted in the shelf 11, the fitting member 61m in the connection conductor module 6 fits with the fitting groove 11m in the shelf 11, and the fitting hole 61n in the connection conductor module 6 fits with the fitting projection 11n in the shelf 11. As a result, the connection conductor module 6 inserted in the shelf 11 is firmly fixed to the shelf 11 without using any screws. The top cover 16 is then placed over the top opening of the shelf 11 in which is inserted the connection conductor module 6. Because the top cover 16 is fixed to the shelf 11 with screws, the connection conductor module 6 will not come out of the shelf 11.

By securing the connection conductor module 6 to the shelf 11 without using any screws, it is possible to improve the insulating performance between the connection conductor unit in the connection conductor module 6 and the shelf 11. It is also possible to improve the insulating performance between the positive potential conductor part and the negative potential conductor part in the connection conductor module 6.

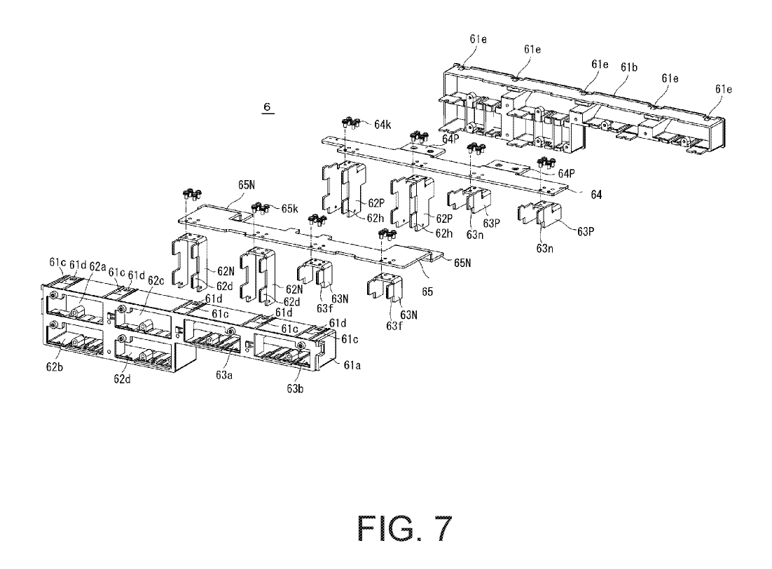

Next, the process of assembling the connection conductor module 6 will be described using FIGS. 7-10.

FIG. 7 shows all the components of the connection conductor module 6 when disassembled.

The connection conductor module 6 is formed from a module case 61 composed of an insulating material, such as an insulating resin, and an electrically conductive connection conductor unit. The module case 61 is divided into and composed of a front case 61a and a rear case 61b. The front case 61a and the rear case 61b are open at the front and rear to form a rectangular tube, and are provided with a plurality of terminal compartments formed separately by partitions. Part of the rear case 61b is inserted into the front case 61a so that both cases fit and connect as a single unit. The front case 61a and rear case 61b are fixed without the use of screws. For this reason, the front case 61a is provided with a plurality of elastic connectors 61c provided with fitting holes 61d at the distal end of the top. In addition, the top of the rear case 61b is provided with a plurality of fitting projections 61e that correspond to and fit together with the fitting holes 61d.

The positive-electrode connection conductor 64 and negative-electrode connection conductor 65, which are retained by the module case 61, are bar-shaped electrical conductors composed of metal plates or the like. Lead-out terminals 64P and 65N for extracting DC power externally are integrally formed in pairs on or near both ends in the width direction of these connection conductors 64 and 65. As a result, DC power can be extracted from both the left and right sides of the uninterruptable power supply device.

The two connection terminals 62P and 63P are each fastened and fixed to the positive-electrode connection conductor 64 by fixing screws 64k. The connection terminal 62P is a terminal that connects to the positive-electrode output terminal of the power supply unit 20. The connection terminal 63P is a terminal that connects to the positive-electrode output terminal of the battery unit 30.

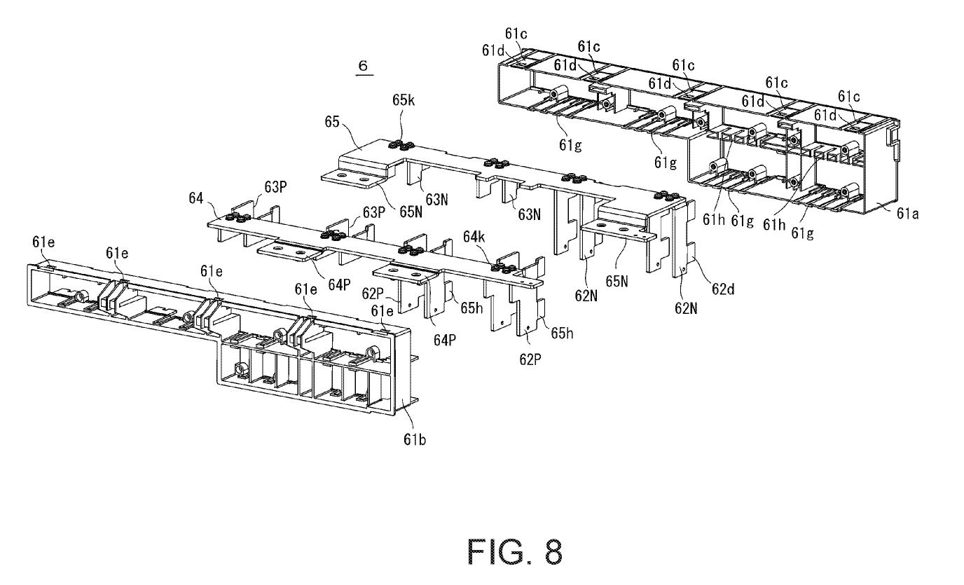

The two connection terminals 62N and 63N are each fastened and fixed to the positive-electrode connection conductor 65 by fixing screws 65k (see FIG. 8). The connection terminal 62N is a terminal that connects to the negative-electrode output terminal of the power supply unit 20. The connection terminal 63N is a terminal that connects to the negative-electrode output terminal of the battery unit 30.

The connection terminals 62P and 62N are each provided with four connection terminal members 62h and 62d, which correspond to the output terminals of the power supply units 20a-20d that are arranged on two levels in two rows. The connection terminals 63P and 63N are each provided with two connection terminal members 63n and 63f, which correspond to the output terminals of the battery units 30a and 30b that are arranged in two rows.

In the front case 61a are formed a plurality of terminal compartments 62(a-d) and 63(a,b) corresponding to the compartments 12(a-d) and 13(a,b) formed in the shelf 11. These terminal compartments 62(a-d) and 63(a,b) accommodate the connection terminals 62(P,N) and 63(P,N) so that the ends of the connection terminal members 62(d,h) and 63(f,n) protrude to the front of the front case 61a.

FIG. 8 shows the connection terminals 62P, 62N, 63P, and 63N when fixed integrally to the connection conductors 64 and 65, as described above. FIG. 8 is a perspective view from the opposite direction of FIG. 7.

When the connection conductors 64 and 65 are inserted in the front case 61a, the edges of the connection terminals 62P, 62N, 63P and 63N that are connected and fixed to the connection conductors 64 and 65 fit into retaining grooves 61g and 61h provided in the bottom wall of the front case 61a. By fitting the edges of the connection terminals 62P, 62N, 63P, and 63N into the retaining grooves 61g and 61h provided in the bottom wall of the front case 61a, the connection conductors 64 and 65 are retained at a predetermined position in the front case 61a.

After insertion of the connection conductors 64 and 65 into the front case 61a, the rear case 61b is inserted and fitted into the front case 61a. At this stage, the fitting projection 61e on the rear case 61b enters underneath the elastic connector 61c on the top of the front case 61a while the elastic connector 61c is pushed up by elastic deformation. Upon reaching the position of the fitting hole 61d provided in the elastic connector 61c on the front case 61a, the fitting projection 61e on the rear case 61b fits into the fitting hole 61d. By fitting the fitting hole 61d with the fitting projection 61e, the front case 61a and rear case 61b are connected and fixed together, and the module case 61 is formed as a single unit. As a result, the connection conductors 64 and 65 incorporated into the front case 61a are held in place from the rear by the rear case 61b, and the connection conductors 64 and 65 are thus fixedly retained by the module case 61.

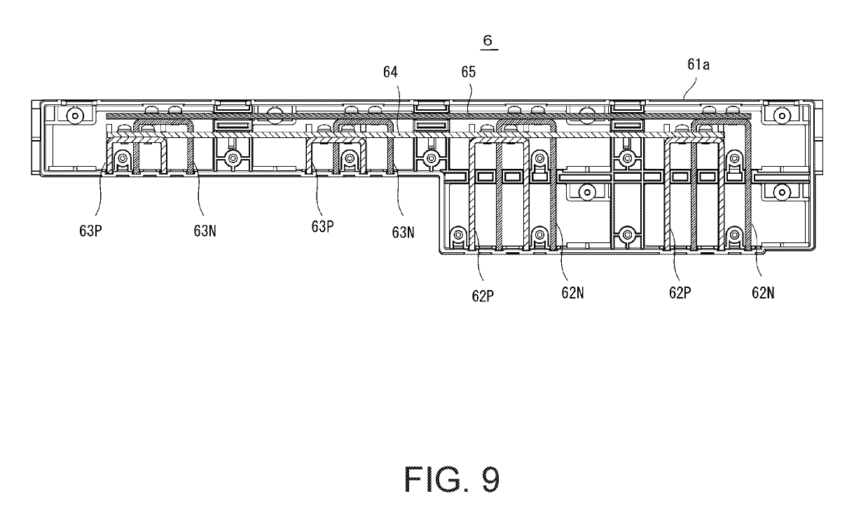

FIG. 9 shows the connection conductors 64 and 65 when inserted into the front case 61a. In FIG. 9, the positive-electrode connection conductor 64 and the connection terminals 62P and 63P connected thereto are shown with thin hatching. The negative-electrode connection conductor 65 and the connection terminals 62N and 63N connected thereto are shown with thick hatching.

As shown in FIG. 9, the positive-electrode connection terminals 62P and 63P and the negative-electrode connection terminals 62N and 63N are arranged alternately along the width of the module case 61.

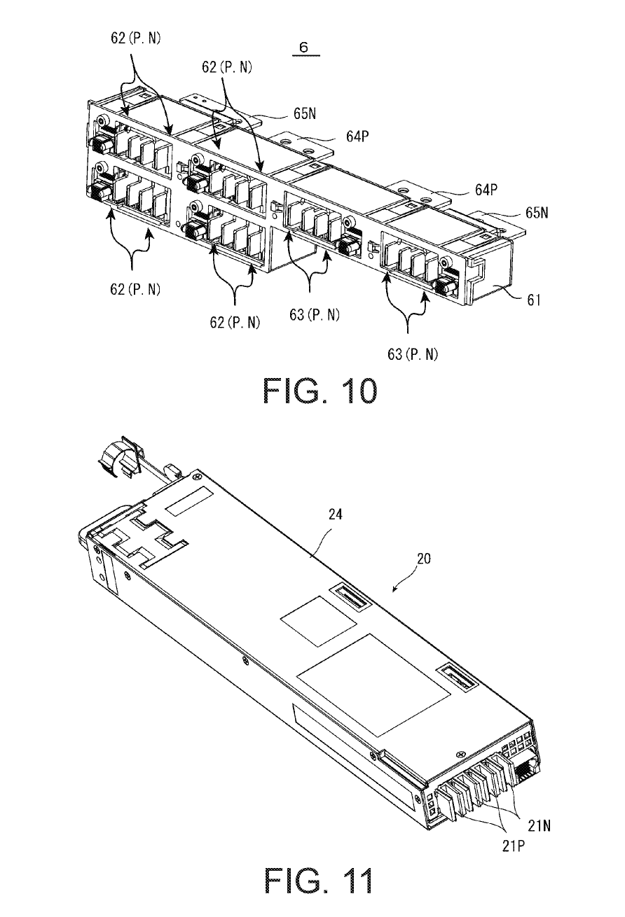

FIG. 10 is an external view of the connection conductor module 6. The module case 61 is composed such that part of the rear case 61b fits into the front case 61a. Accordingly, when viewed externally the module case 61 has the appearance of a substantially single unit, with almost no visible evidence (dividing line) of the connection between the front case 61a and the rear case 61b.

FIG. 11 is an external view of the power supply unit 20.

The power supply unit 20 accommodates an AC/DC converter 22 and a DC/DC converter 23 within a unit case 24. A positive-electrode output terminal 21P and a negative-electrode output terminal 21N for outputting DC power are provided in two groups at the rear of the power supply unit 20. The positive-electrode output terminal 21P and the negative-electrode output terminal 21N are provided in two groups in order to reduce the flow of current per terminal, and in order to reduce contact resistance between the electrical connections and the connection conductor module 6.

The output terminals 21P and 21N are formed as contact-type female terminals. The connection terminal members 62(d,h) and 63(f,n) of the connection conductor module 6 that connect to the output terminals 21P and 21N are formed as flat, male terminals, as shown in FIG. 10. In addition, although not illustrated, the output terminals 31P and 31N of the battery unit 30 are also formed as contact-type female terminals with the same shape as the output terminals 21P and 21N of the power supply unit 20.

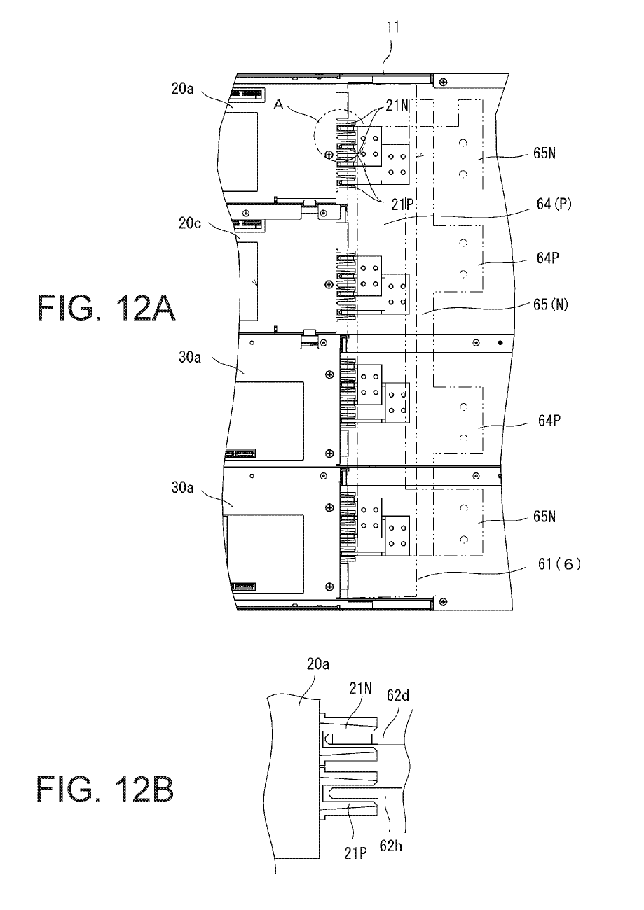

FIGS. 12A and 12B show the connection conductor module 6 when inserted and fixed into the shelf 11 of the uninterruptible power supply device 10. The connection terminal members 62(d,h) of the connection conductor module 6 are inserted in the spaces of the output terminals 21P and 21N of the power supply unit 20 and thus sandwiched by the output terminals 21P and 21N. As a result, electrical connection between the power supply unit 20 and the connection conductor module 6 occurs at the front opening of the module case 61. Although not illustrated, the connection terminal members 63(f,n) of the connection conductor module 6 are similarly inserted in the spaces of the output terminals 31P and 31N of the battery unit 30 and thus sandwiched by the output terminals 31P and 31N. As a result, electrical connection occurs between the battery 30 and the connection conductor module 6.

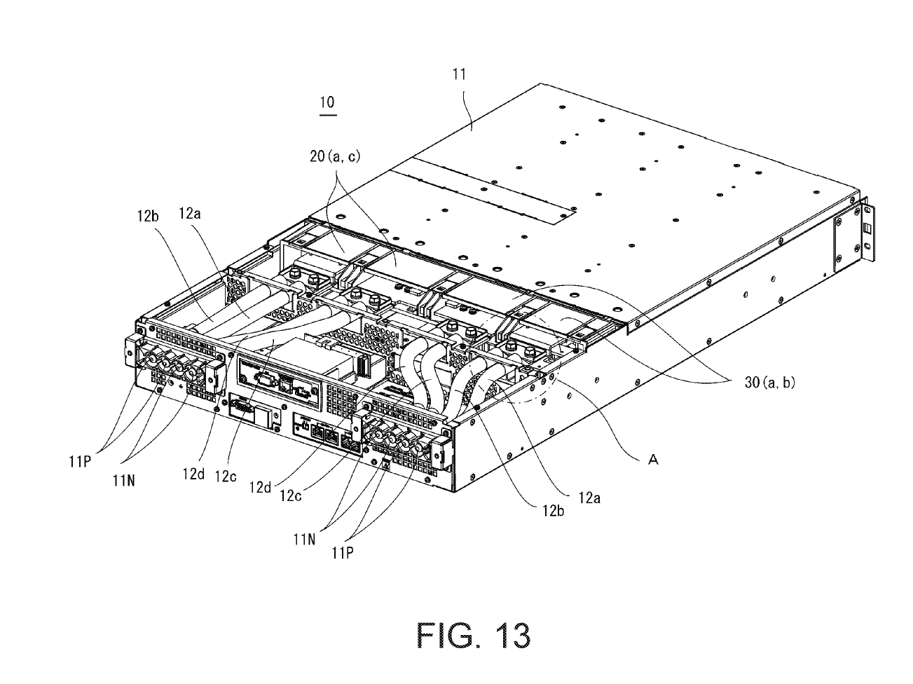

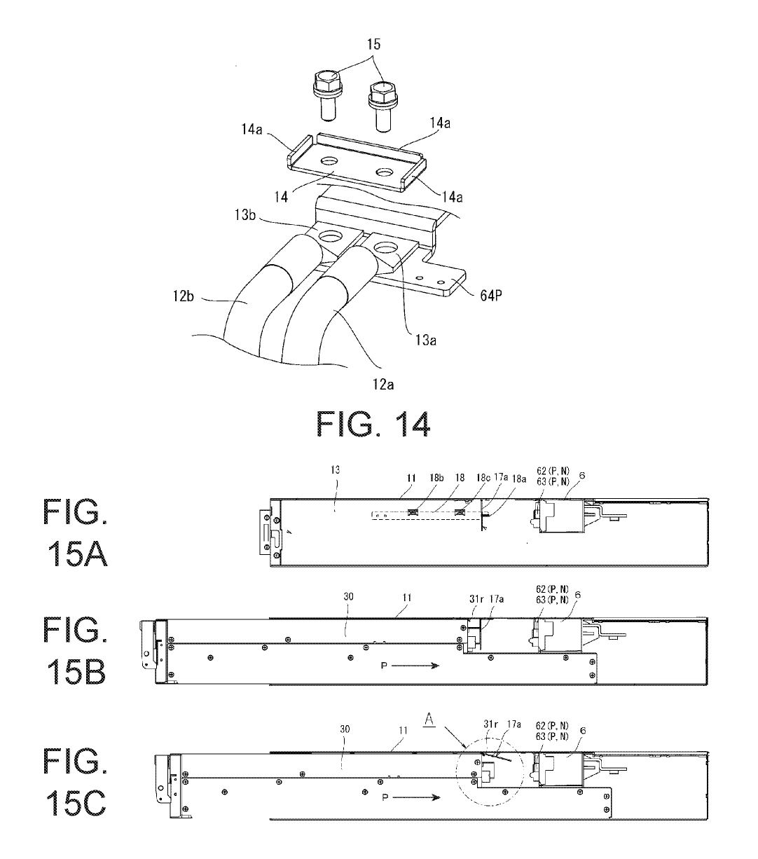

Next, the connection structure between the connection conductor module 6 and the uninterruptible power supply device 10 is described with reference to FIGS. 13 and 14. As described above, the uninterruptible power supply device 10 is composed of a power supply unit 20, battery unit 30 and connection conductor module 6 accommodated within a metal shelf 11.

External output terminals 11P and 11N are provided at the rear of the shelf 11 of the uninterruptible power supply device 10. The external output terminals 11P and 11N are connected to external lead-out terminals 64P and 65N of the connection conductor module 6 by a connection line 12. As a result, the external output terminals 11P and 11N of the uninterruptible power supply device 10 are connected to the output terminals of the power supply unit 20 and battery unit 30 within the shelf 11 via the connection line 12 and the connection conductor module 6. It is desirable to use flexible insulated wire as the connection line 12 in order to facilitate the work of connecting the external output terminals 11P and 11N to the external lead-out terminals 64P and 65N of the connection conductor module 6.

The uninterruptible power supply device 10 outputs low-voltage high-current DC power. Accordingly, the connection line 12 is composed of two positive-electrode connection lines 12a and 12b and two negative-electrode connection lines 12c and 12d, as shown in FIG. 13. Because electrical resistance is halved when two connection lines are connected in parallel in this way to form the connection line 12, resistance loss in the connection line 12 can be decreased. As a result, the overall efficiency of the uninterruptible power supply device 10 can be increased.

FIG. 14 shows the structure of a terminal provided in the uninterruptible power supply device 10 of one embodiment of the present invention. This figure shows a working example of a terminal structure for connecting two connection lines 12a and 12b in parallel with the lead-out terminal 64P of the connection conductor module 6.

Rectilinear connection terminals 13a and 13b are connected to one end of the connection lines 12a and 12b. The two connection terminals 13a and 13b are arranged in a line on the rectilinear lead-out terminal 64P. In addition, a rectilinear pressing plate 14 of substantially the same size as the lead-out terminal 64P is arranged above the connection terminals 13a and 13b. The lead-out terminal 64P and pressing plate 14 that sandwich the connection terminals 13a and 13b are fastened at uniform pressure by fastening bolts 15a and 15b. As a result, the connection terminals 13a and 13b are fixed to the lead-out terminal 64P at uniform pressure.

The pressing plate 14 is formed from rectangular iron plate with high mechanical rigidity and high thermal conductivity, and has tin coating applied to the surface thereof.

With this type of configuration, the entire contact surface of the connection terminals 13a and 13b can be brought into contact with the lead-out terminal 64P at substantially uniform pressure. As a result, contact resistance can be reduced between the contacting portions of the connection terminals 13a and 13b and the lead-out terminal 64P. Consequently, it is possible to suppress bias in the current flowing to the two connection terminals 13a and 13b and to reduce loss arising from contact resistance at the terminals.

In the same way, connection terminals 13c and 13d are connected to one end of the connection lines 12c and 12d. The lead-out terminal 65N and pressing plate 14 that sandwich the connection terminals 13c and 13d are fastened at uniform pressure by fastening bolts 15a and 15b. As a result, the connection terminals 13c and 13d are fixed to the lead-out terminal 65N at uniform pressure.

Accordingly, the entire contact surface of the connection terminals 13c and 13d can be brought into contact with the lead-out terminal 65N at substantially uniform pressure. As a result, contact resistance can be reduced between the contacting portions of the connection terminals 13c and 13d and the lead-out terminal 65N. Consequently, it is possible to suppress bias in the current flowing to the two connection terminals 13c and 13d and to reduce loss arising from contact resistance at the terminals.

The pressing plate 14 can be formed from a material other than iron plate, such as stainless steel, as long as the material has high mechanical rigidity and high thermal conductivity. Furthermore, part of the outer edge of the pressing plate 14 is bent at right angle and raised up several millimeters to form a raised member 14a. This raised member 14a serves the functions of increasing the rigidity of the pressing plate 14 and enlarging the surface area to increase heat dissipation. As a result, heat dissipation can be improved at the terminal connection part and temperature increase in this part can be suppressed.

Next, a mechanism provided with the uninterruptible power supply device 10 according to one embodiment of the present invention in order to prevent the occurrence of electric shock and short-circuit accidents is described with reference to FIGS. 15A to 15C to FIGS. 18A and 18B. The uninterruptible power supply device 10 described here is composed of a power supply unit 20, a battery unit 30 and a connection conductor module 6 accommodated within a metal shelf 11, in the same way as in the uninterruptible power supply device 10 described above. Maintenance and inspection of the uninterruptible power supply device 10 will generally involve removal of a part of the power supply unit 20 or battery unit 30 from the shelf 11 in the uninterruptible power supply device 10.

As shown in FIG. 2A, the cross-sectional area of the compartment 13 housing the battery unit 30 is larger than the cross-sectional area of the compartment 12 housing the power supply unit 20. It is therefore easy to insert a hand or tool into the compartment 13 when the battery unit 30 has been removed.

It is not easy to insert a hand into the compartment 12 housing the power supply unit 20 because the cross-sectional area of the compartment 12 is small. However, a thin, rod-shaped tool such as a screwdriver can be inserted with comparative ease.

When the power supply unit 20 or battery unit 30 is removed from the shelf 11, the connection terminals 62P, 62N, 63P, and 63N of the connection conductor module 6 are exposed in the interior of the compartments 12 and 13. With the connection terminals 62P, 62N, 63P, and 63N of the connection conductor module 6 exposed in this way, there is a danger that if a hand were inserted into the compartments 12 and 13 from the front of the shelf 11, the hand could touch the terminals and receive an electric shock. In addition, if a tool or the like is inserted into the compartments 12 and 13 after removal of the power supply unit 20 or battery unit 30, there is a danger that this tool or the like could touch the connection terminals 62P, 62N, 63P, and 63N and cause a short circuit of the DC power supply.

In order to prevent this type of danger, the uninterruptible power supply device 10 shown in FIG. 15A is provided with a compartment-shielding mechanism using a flap mechanism 17 positioned between the insertion slot of the compartment 13 and the front of the connection conductor module 6. The flap mechanism 17 consists of a flap 17a and a latch plate 18.

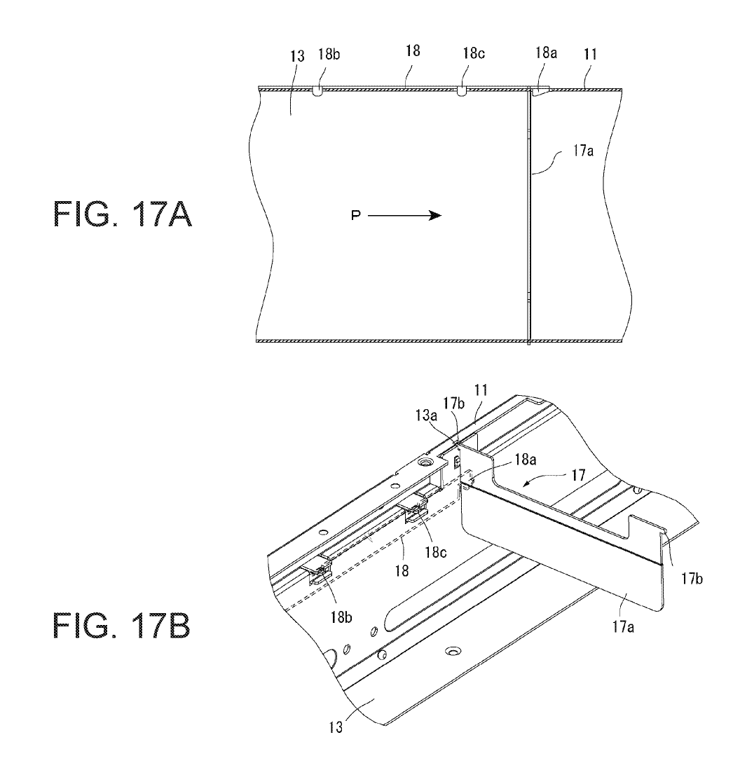

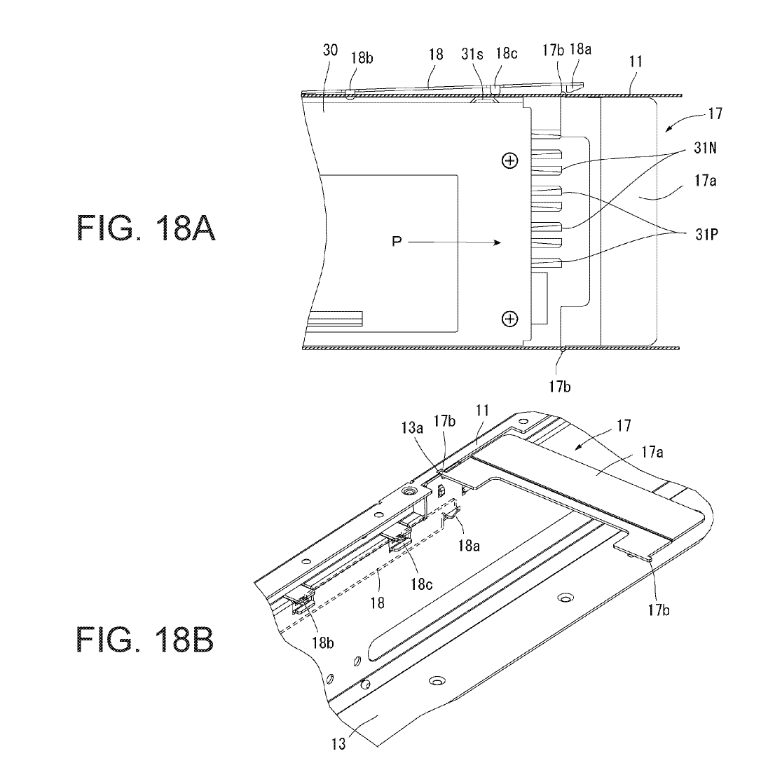

As shown in detail in FIGS. 17A, 17B and 18, the flap 17a is sheet-shaped and has a pair of supporting projections 17b and 17b formed so as to project externally at the top on both sides. By the insertion of these supporting projections 17b and 17b into a bearing hole 13a provided at the top of each side wall of the compartment 13, the flap 17a is able to rotate while being supported within the compartment 13.

As shown in FIG. 15A, when the battery unit 30 is removed from the compartment 13, the flap 17a hangs down vertically due to gravity and closes the front of the connection conductor module 6.

The uninterruptible power supply device 10 is also provided with the latch plate 18 for ensuring that the flap 17a will not rotate in this position even when a hand or the like is inserted into the compartment 13. By means of this flap mechanism 17 it is possible to prevent a hand or the like inserted into the compartment 13 from touching the connection terminals 62P, 62N, 63P, and 63N of the connection conductor module 6.

FIGS. 17A and 17B show the detailed structure of the flap mechanism 17; FIG. 17A is an enlarged, sectional plan view showing the flap mechanism 17 part, and FIG. 17B is a partially cut away, enlarged perspective view of the same part.

As shown in these figures, when the flap 17a is hanging vertically, the flap 17a closes the front of the connection conductor module 6. In this state, the flap 17a is latched by the latch plate 18 so that the flap 17a cannot be pushed open by external force.

This latch plate 18 is composed of a spring member, is provided at the end thereof with a hook-shaped latch member 18a, and is arranged outside the compartment 13. The proximal part of the latch plate 18 on the side opposite the end provided with the latch member 18a is fixed to the external wall of the compartment 13, which is the external wall of the shelf 11. In addition to being provided with the latch member 18a at the end thereof, the latch plate 18 is also provided with two pressing projections 18b and 18c in the middle thereof that project into the compartment 13 side.

When the battery unit 30 has been removed from the compartment 13 and the flap 17a is hanging down vertically, the latch plate 18 presses against the external wall of the compartment 13 by means of the spring force of the latch plate 18. As a result, the latch member 18a provided at the end thereof, and the pressing projections 18b and 18c provided in the middle thereof, penetrate into the compartment 13 via through-holes provided in the external wall of the compartment 13.

The latch member 18a that has penetrated the compartment 13 catches the flap 17a from the rear by pressing the rear of the perpendicular flap 17a. As a result, rotation of the flap 17a is prevented even when a pressing force P indicated by the arrow is applied to the rear side of the flap 17a.

Consequently, because the flap 17a hangs down vertically and closes the front of the connection conductor module 6, it is possible to reliably prevent a hand, tool or the like that is inserted into the compartment 13 from accidentally being exposed to the connection conductor module 6 and touching a connection terminal.

FIG. 15B shows the battery unit 30 during insertion into the compartment 13. This figure shows the exact moment when a projection 31r provided on the top of the battery unit 30 has reached the position where the flap 17 is installed. In this situation, as shown in FIG. 18A, a pressing member 31s provided on the side wall of the battery unit 30 touches the pressing projection 18c of the latch plate 18 that has penetrated the compartment 13.

As a result of the pressing member 31s touching the pressing projection 18c, the latch plate 18 undergoes elastic deformation and the pressing projection 18c and latch member 18a are pushed outside the compartment 13. When the latch member 18a is pushed outside the compartment 13, the flap 17a is released and is therefore able to rotate.

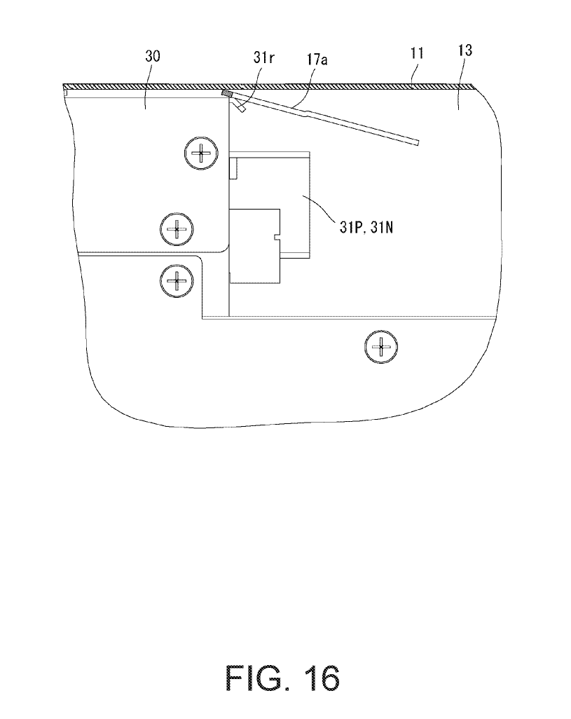

At this point, when the battery unit 30 is pushed further into the compartment 13, the projection 31r of the battery unit 30 touches the flap 17a, as shown in FIG. 15C. The section containing the projection 31r is enlarged in FIG. 16 to show this situation more clearly.

When the battery unit 30 is pushed in further, the flap 17a is pushed by the projection 31r and rotates upwards. The rotated flap 17a becomes horizontal at the top of the compartment 13, as shown in FIGS. 18A and 18B. As a result, the compartment 13 becomes completely open. By pushing in the battery unit 30 further from this point, the output terminals 31P and 31N of the battery unit 30 fit with the connection terminal members 62P, 62N, 63P and 63N of the connection conductor module 6 and are electrically connected.

When the battery unit 30 is removed from the compartment 13, the projection 31r at the end of the battery unit 30 is separated from the flap 17a. The flap 17a then loses support from underneath, rotates downwards under the weight thereof and hangs down vertically. With the removal of the battery unit 30, the pressure on the latch plate 18 by the pressing member 31s of the battery unit 30 is released. The latch plate 18 then returns by the spring force thereof to the position in contact with the outer wall of the shelf 11. As a result, the latch member 18a enters into the compartment 13 of the shelf 11. Having entered the compartment 13 of the shelf 11, the latch member 18a catches the lower edge of the flap 17a and prevents rotation of the flap 17a. In this way, it is possible to reliably prevent a hand, tool or the like that has been inserted into the insertion slot of the compartment 13 from touching a connection terminal of the connection conductor module 6, while at the same time making it possible to insert the battery unit 30.

Although the compartment 12 accommodating the power supply unit 20 has a small cross-sectional area, a rod-shaped tool such as a screwdriver could be inserted. Accordingly, to prevent such accidents arising through tool contact, a compartment-shielding mechanism using a flap mechanism 17 of the same type as in the compartment 13 of the battery unit 30 can be provided in compartment 12 accommodating the power supply unit 20.

It will be apparent to those skilled in the art that various modifications and variations can be made in the present invention without departing from the spirit or scope of the invention. Thus, it is intended that the present invention cover modifications and variations that come within the scope of the appended claims and their equivalents. In particular, it is explicitly contemplated that any part or whole of any two or more of the embodiments and their modifications described above can be combined and regarded within the scope of the present invention.

What is claimed is:

1. A power supply device for supplying DC power, comprising:
a plurality of power conversion units that output said DC power;
a connection conductor module that connects in parallel output terminals of said plurality of power conversion units; and
a shelf that accommodates the plurality of power conversion units and said connection conductor module,
wherein the connection conductor module comprises a module case made of an insulating material and connection conductors accommodated within said module case.

2. The power supply device according to claim 1,
wherein said module case has an opening in a surface facing said plurality of power conversion units,
wherein said connection conductors include terminals to fit with said output terminals of the plurality of power conversion units, and
wherein the terminals of said connection conductors fit and connect with the output terminals of the plurality of power conversion units at said opening.

3. The power supply device according to claim 1,
wherein said module case comprises a first case and a second case, and
wherein said connection conductors are fixed and retained inside the module case by the fitting together of said first case and said second case.

4. The power supply device according to claim 3, wherein said connection conductors are installed and fixed in a retaining groove provided in said first case or said second case.

5. The power supply device according to claim 1, wherein said connection conductor module includes a fitting to fit with a fitting provided on at least one of a side wall and a bottom wall of said shelf.

6. The power supply device according to claim 1, wherein said connection conductors and said shelf are insulated by said module case at a top, bottom, and both sides of said connection conductor module.

7. The power supply device according to claim 1, wherein each of said plurality of power conversion units that output DC power is either a power supply unit that converts power from an AC power supply to DC power and outputs the same, or a battery unit that converts battery power to DC power and outputs the same.

8. The power supply device according to claim 1, wherein said connection conductors include a pair of terminals of positive polarity and negative polarity provided on both left and right sides of said power supply device, for extracting said DC power externally.

9. A server power supply system, comprising a server rack; and the power supply device according to claim 1 accommodated in said server rack.

10. A server system, comprising a server rack housing a server; and the power supply device according to claim 1 accommodated in said server rack housing said server.
